(19) United States
(12) Patent Application Publication
(10) Pub. No.: US 2024/0223045 A1
(43) Pub. Date: Jul. 4, 2024

(54) APPARATUS, SYSTEM, AND METHOD FOR AN ELECTROMECHANICAL KINETIC MOTOR

(71) Applicant: Tynergy LLC, Sheridan, WY (US)

(72) Inventors: Timothy Reese, Hurricane, UT (US); Yan Purba, Draper, UT (US)

(21) Appl. No.: 18/401,312

(22) Filed: Dec. 29, 2023

Related U.S. Application Data
(60) Provisional application No. 63/436,420, filed on Dec. 30, 2022.

(51) Int. Cl. H02K 7/20; H02K 1/16; H02K 1/272; H02K 15/00

(52) U.S. Cl. CPC H02K 7/20; H02K 1/16; H02K 1/272; H02K 15/00

(57) ABSTRACT

An electromechanical kinetic motor including a frame, a stator, a rotor, a power source, and an electric load. The stator is connected to the frame and includes a coil. The rotor is rotatably connected to the frame and includes a magnet. The power source is electrically connected to the coil. The electric load is connected to the coil and configured to extract power from the coil. The coil generates an electromagnetic field in response to electricity provided by the power source. The rotor is configured to rotate the magnet through the magnetic field generated by the coil. An electric current is induced in the coil by the rotation of the magnet through the electromagnetic field generated by the coil.

### CROSS-REFERENCE TO RELATED APPLICATIONS

This application claims the benefit of U.S. Provisional Patent Application No. 63/436,420, entitled “ELECTRO-MAGENTO-MECHANICAL POWER GENERATOR,” which was filed on Dec. 30, 2022, and is hereby incorporated by reference.

### SUMMARY

Embodiments of an electromechanical kinetic motor are described. The electromechanical kinetic motor includes a frame, a stator, a rotor, a power source, and an electric load. The stator is connected to the frame and includes a coil. The rotor is rotatably connected to the frame and includes a magnet. The power source is electrically connected to the coil. The electric load is connected to the coil and configured to extract power from the coil. The coil generates an electromagnetic field in response to electricity provided by the power source. The rotor is configured to rotate the magnet through the magnetic field generated by the coil. An electric current is induced in the coil by the rotation of the magnet through the electromagnetic field generated by the coil.

### BRIEF DESCRIPTION OF THE SEVERAL VIEWS OF THE DRAWINGS

FIG. 1 depicts a perspective view of one embodiment of an electromechanical kinetic motor.

FIG. 2 depicts one embodiment of a schematic diagram for a system for the electromechanical kinetic motor of FIG. 1.

FIG. 3 depicts multiple views of one embodiment of a prototype electromechanical kinetic motor configured with one alternator.

FIG. 4 depicts multiple views of a prototype electromechanical kinetic motor configured with two alternators.

FIG. 5 depicts a perspective view of an electromechanical kinetic motor prototype.

FIG. 6 depicts an embodiment of an electromechanical kinetic motor that uses more than two permanent magnets for the stator and rotor.

FIG. 7 is a flowchart diagram depicting one embodiment of a method for manufacturing an electromechanical kinetic motor.

Throughout the description, similar reference numbers may be used to identify similar elements.

### DETAILED DESCRIPTION

In the following description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

While many embodiments are described herein, at least some of the described embodiments provide a system for an electromechanical kinetic motor.

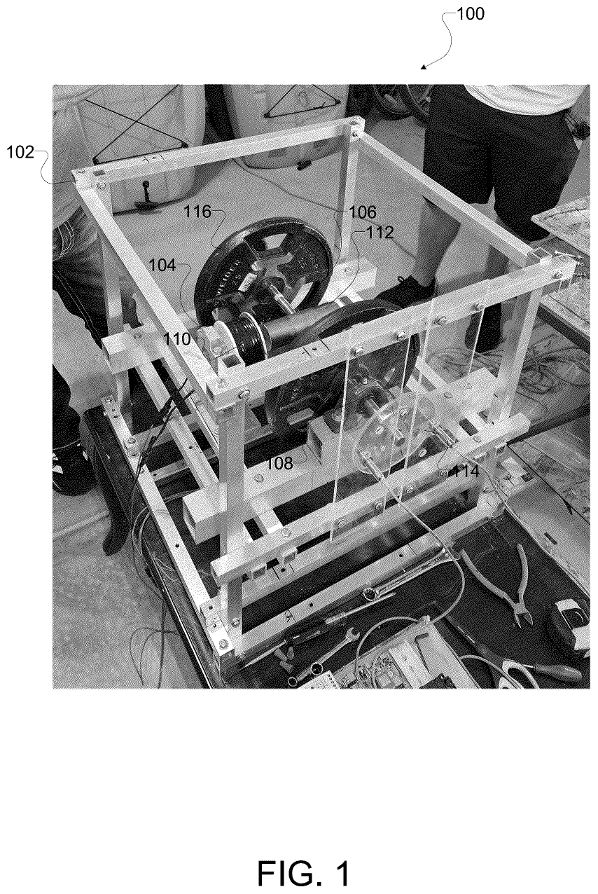

FIG. 1 depicts a perspective view of one embodiment of an electromechanical kinetic motor 100. The electromechanical kinetic motor 100 includes a frame 102, a stator 104, and a rotor 106. The electromechanical kinetic motor 100 causes the rotor 104 to rotate.

In some embodiments, the frame 102 provides attachment points for orienting and retaining components of the electromechanical kinetic motor 100 relative to one another. The frame 102 may include one or more bearings 108 to allow a component, such as the rotor 106, to rotate relative to the frame 102. The bearings 108 may be any type of bearing known in the art, such as a journal bearing, a ball bearing, a roller bearing, or any other type of bearing.

The stator 104, in some embodiments, is connected to the frame 102 so as to restrict rotation and translation of the stator 104 relative to the frame 102. The stator 104 may include one or more coils 110. The coils 110 may each include a conductive wire wound around a core. Electric current passing through the coil 110 may cause the coil 110 to act as an electromagnet.

The wire may be any type of wire used in the art for creating electromagnets. In some embodiments, the wire is a copper wire. In another embodiment, the wire may be aluminum wire. The wire may be any thickness of wire used in the art for creating electromagnets. In one embodiment, the wire is a 20 gauge wire. In other embodiments, the wire is between 24 and 16 gauge wire.

In certain embodiments, the wire is wound around the core a plurality of times such that the resistance of the wire reaches a preselected resistance. In one embodiment, the preselected resistance is ten ohms. In other embodiments, the preselected resistance is between five and twenty ohms.

In some embodiments, the electromechanical kinetic motor 100 includes one coil 110. In other embodiments, the electromechanical kinetic motor 100 includes a plurality of coils 110. The electromechanical kinetic motor 100 may include one or more pairs of coils 110. Each pair of coils 110 may be positioned such a first coil and a second coil are on opposite sides of the rotor 106. In other words, if a component of the rotor 106 is at its smallest distance to the first coil of the pair of coils 110 at a first angle of rotation of the rotor 106, the component of the rotor 106 will be at its smallest distance to the second coil of the pair of coils 106 when the rotor rotates 180 degrees from the first angle of rotation of the rotor 106.

The rotor 106, in some embodiments, is rotatably connected to the frame 102 such that the rotor is rotatable relative to the frame 102 and other components of the electromechanical kinetic motor 100. In certain embodiments, components of the rotor 106 pass through a magnetic field generated by the coil 110 in certain phases of rotation of the rotor 106.

In certain embodiments, the rotor 106 includes one or more magnets 112. The magnets 112 may be any type of magnet known in the art. In some embodiments, the magnets 112 are rare earth magnets. In one embodiment, the magnets 112 are neodymium magnets. The magnets 112 may be any size or shape known in the art. In some embodiments, the magnets 112 are cylindrical with a diameter of two inches and a height of two inches. Cylindrical magnets 112 may be axially magnetized such that they have a north magnetic end and a south magnetic end at opposite ends of the axis of the cylinder. The magnets 112 may be any grade or strength known in the art. For example, the magnets 112 may be N52 neodymium magnets. In other embodiments, the magnets may be a grade between or including N35 and N52.

In some embodiments, rotation of the rotor 106 may cause the magnets 112 to pass through a magnetic field generated by the coil 110. At certain angles of rotation of the rotor 106, the magnetic field generated by the coil 110 may attract the magnets 112 and generate a force that induces rotation of the rotor 106 to bring the magnets 112 closer to the coil 110. At other angles of rotation of the rotor 106, the magnetic field generated by the coil 110 may repel the magnets 112 and generate a force that induces rotation of the rotor 106 to push the magnets 112 farther from the coil 110.

In some embodiments, the electromechanical kinetic motor 100 includes an angle sensor 114. In response to the rotor 106 being at a particular rotational position, the angle sensor 114 generates a signal that indicates that the rotor 106 is in the particular rotational position. In response to the signal from the angle sensor 114, a control circuit may cause electric current to flow to the coil 110 or cause electric current to cease flowing to the coil 110. In some embodiments, the control circuit may reverse the polarity of electric current to the coil 110 in response to the signal from the angle sensor 114. The control circuit may apply, remove, or reverse the electric current applied to the coil 110 multiple times during a single rotation of the rotor 106.

In certain embodiments, the electromechanical kinetic motor 100 includes a flywheel 116. The flywheel 116 is connected to the rotor 106 and rotates with the rotor 106. The flywheel 116 may add rotational inertia to the rotor 106. In other words, the flywheel 116 may store energy as rotational momentum. The flywheel 116, in certain embodiments, is substantially disc shaped. The flywheel 116 may include any material with a relatively high mass. For example, the flywheel 116 may be made from metal, stone, or composite materials. In one embodiment, the flywheel 116 is a steel plate weighing 25 pounds. In some embodiments, the flywheel 116 weighs between 10 and 1000 pounds. The flywheel 116 may be any weight, shape, or material capable of storing rotational momentum.

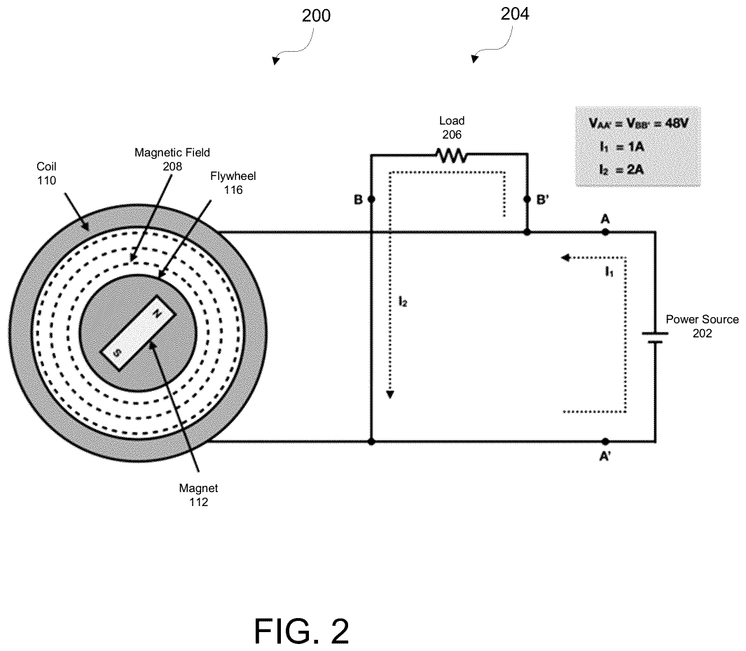

FIG. 2 depicts one embodiment of a schematic diagram for a system 200 for an electromechanical kinetic motor 100. The system 200 essentially functions to convert electricity from electricity source 102 into kinetic energy and electrical energy. In this sense, the electromechanical kinetic motor 100 can be viewed as a magnetic energy electricity regenerator producing kinetic energy. One embodiment of an electromechanical kinetic motor 100 includes: A power source 202 such as a battery to supply source power to the power circuit 200, a magnet 112 (e.g., a neodymium permanent magnet), a flywheel 116 supporting the magnet 112, one or more coils 110 covering a region around the magnet 112, and a power circuit 204 that transmits electrical energy throughout the system 200.

In this embodiment, the magnet 112 is mounted such that it rotates with the flywheel 116. In one embodiment, the flywheel 116 is free to rotate about an axis that is substantially perpendicular to the Earth's surface. In other embodiments, the flywheel 116 may be configured to rotate around any arbitrarily-selected spatial axis. The coil 110 (electromagnetic coil assembly) may be spatially configured similar to a coil arrangement in an electrical motor. The coil 110 may include multiple pairs of electrical coils. Each pair of electrical (electromagnetic) coils may generate a magnetic field 208 including an electromagnetic North pole and a magnetic South pole when electricity flows through the electrical coils. The arrangement of the electrical coils may sequentially generate multiple such electromagnetic pairs of a North pole and a South pole in the space surrounding the magnet 112 and the flywheel 116.

In some embodiments, the power circuit 204 is powered by the power source 202. The power source 204 may be any direct current power source used in the art. In one embodiment, the power source 204 is a battery. For example, the power source may be a 48 volt DC battery.

In certain embodiments, a load 206 is connected in parallel with the power source 202. The coil 110 may be connected in parallel with the load 206. The coil 110 generates a magnetic field when the power source 202 is switched on and current flows through the coil 110.

In some embodiments, the magnet 112 is rigidly affixed to the flywheel 116 and the assembly comprising the magnet 112 and the flywheel 116 is placed within the region of the magnetic field 208 generated by the coil 110. The region of the magnetic field 208 generally overlaps the magnet 112 and flywheel 116; this aspect is not shown in FIG. 2 for the sake of clarity.

When the power source 202 is switched on, the magnetic field 208 is generated by the coil 110 and interacts with the magnet 112, exerting a force on the magnet 112. This force may be an attractive force or a repulsive force, depending on the polarity of the magnetic field 208 with respect to an orientation of the magnet 112. The magnet 112 and flywheel 116 assembly may be constrained so as to allow only a rotation motion about an axis that is substantially perpendicular to the plane of FIG. 2. Thus, the magnet 112 and flywheel 116 assembly may rotate in a clockwise or a counterclockwise direction in the view depicted in FIG. 2. Due to the rotational motion of the magnet 112, the magnetic field of the permanent magnet interacts with the magnetic field 208 generated by the coil 110. This interaction causes an electric voltage to be induced in the coil 110. This electric voltage is fed back into the circuit 204 by the coil 110.

In one aspect, a current flows through the load 206 due to a combination of current supplied by the power source 202, and current generated from the electric voltage generated by the electric voltage in the coil 110. For example, a current generated by the power source 202 may be 1 A, for a total power output of 48 W from the power source 202. The current flowing through the load 206 may be 2 A. As seen in the circuit diagram presented in FIG. 2, the voltage across the load 206 is also 48 V. This results in a total power of 96 W delivered to the load 206. This total power is greater than the power supplied by the battery alone because an additional power component is being contributed to the load by the electrical voltage generated by the electrical coil assembly due to motion of the permanent magnet. The electromechanical kinetic motor 100 thus acts like an energy regenerator, or energy amplifier. The load 206 could be, for example, a rechargeable battery.

One embodiment of the electromechanical kinetic motor 100 includes the coil 110 comprised of multiple pairs of stators. Each pair of stators includes an electromagnetic coil 110 subassembly pair that can generate a magnetic field. In each pair of stators, one electromagnetic coil subassembly can generate a North pole, while the other electromagnetic coil subassembly can generate a South pole.

In some embodiments, an electromagnetic coil subassembly corresponding to an adjacent stator pair may have an electric current that is reverse in direction to the current stator pair. In one aspect, relay circuitry may be configured such that as the magnet 112 passes through the current stator pair while rotating, the current flowing through the electromagnetic coil subassembly corresponding to the current stator pair generates a magnetic field that exerts a repulsive force on the magnet 112, pushing the magnet 112 to rotate towards the subsequent stator pair. At the same time, the current flowing through the electromagnetic coil subassembly corresponding to the subsequent stator pair may generate a magnetic field that exerts an attractive force on the magnet 112, pulling the magnet 112 towards the subsequent stator pair. As the magnet 112 passes an approximate axis of symmetry corresponding to the subsequent stator pair, the control circuit may reverse the direction of current flowing through the electromagnetic coil subassembly corresponding to the subsequent stator pair. This further reverses the magnetic field, which now exerts a repulsive force on the magnet 112, pushing the magnet 112 towards a stator pair subsequent to the subsequent stator pair. That stator pair may flow current that attracts the magnet 112, and so on. Such a time-varying magnetic field generated by the multiple pairs of stators in combination with the rotational inertia of the magnet 112 and flywheel 116 assembly keeps the magnet 112 in continuous motion as long as the time-varying magnetic field is maintained.

In certain embodiments, a control circuit including a combination of relay switches is used to periodically energize each pair of stators sequentially, creating a time-varying magnetic field in the region of the magnetic field. Due to the time-varying magnetic field, the magnet 112 moves continuously in rotational motion. When the angular position of the magnet 112 in space while moving is such that each pole of the magnet 112 is between successive stator pairs, the rotational inertia of the combination of the magnet 112 and flywheel 116 maintain the motion, moving the magnet 112 to the subsequent stator pair. The operation of the electromechanical kinetic motor 100 includes properties of an electric motor and a dynamo operating in unison.

In one aspect, the flywheel 116 is selected to have a mass of approximately 50 pounds. An assembly that includes the flywheel 116 and the magnet 112 may have a mass of approximately 100 pounds. A larger mass results in higher rotational inertia for the assembly.

In certain embodiments, the electromechanical kinetic motor 100 leverages magnetism, electricity, and mechanical motion to regenerate or amplify electrical energy. These three energy systems work independently but also in combination to implement the functionality of the electromechanical kinetic motor.

In some embodiments, the electromechanical kinetic motor includes a flywheel 116. The flywheel 116 is constructed from a set of bearings which are lubricated by grease to reduce the amount of friction or resistance. The flywheel 116 may rotate upon a spindle. The entire assembly may be mounted on a rectangular frame 102.

In one aspect, the flywheel 116 is constructed of a steel core welded onto a shaft that enables the attachment of 2 or more N52 neodymium magnets 112. To enable the two cylindrically-formed magnets 112 to develop a single domain magnetic field, the north ends are always attached to the south ends beginning with the first N52 magnet 112. Having a single domain magnetic field enables the control of the magnetic flux that will pass through the coils of the electromagnet.

Analysis of the energy amplification includes measuring the total magnetic flux generated and the amount of electricity generated. The rotational system comprising the magnet 112 and the flywheel 116 may be described as a rotor 106.

The next energy system may be referred to as an electromagnetic stator 104. The electromagnetic stator 104 helps the rotor 106 rotate around its axis which is perpendicular to the rotation plane of the rotor 106. The electromagnetic stator 104 combined with the rotor 106 will likely produce electricity given Faraday's law of induction states, “Any change in the magnetic environment of a coil of wire will cause a voltage (emf) to be “induced” (phenomenally) in the coil. No matter how the change is produced, the voltage will be generated.” This property is used to generate voltage (emf) as the magnet 112 attached to the rotor 116 interacts with the electromagnetic stator 104.

In one aspect, the electromagnetic stator 104 includes a coil 110 made of a 0.5-2.0 inch diameter cylindrical steel core with winding of coils of copper wire.

In certain embodiments, the amount of electricity needed to energize the coil 110 to become an electromagnet which will create a force to push the flywheel 116 into rotation will be set at 48 volts and 1 amps, as depicted in FIG. 2. The electromagnet will be used to reverse the magnetic flux generated by the electromagnet, alternating the current in the coil 110 from positive to negative, then reverting negative to positive at certain positions of the rotor 106. This alternating of current in the coil 110 will enable the magnetic forces needed to interact with the magnet 112. When the rotor 106 is positioned north at 0 degrees, the coil 110 will be charged with enough voltage to set the electromagnet to north since the magnet 112 is positioned where the South pole of the magnet will pull the rotor 106 closer to the coil 110 that is charged with a North pole configuration.

Because like poles push against each other and unlike poles attract, the electromechanical kinetic motor 100 includes a timed reversing of the magnetic poles with software controls. In order to sufficiently power the electromagnet and not lose the power used to energize the electromagnet, energy may be harvested from the rotating magnet 112. The energy generated from the rotating magnet 112 approaching the coil 110 is embedded in the power circuit 204. Because of this closed loop circuitry with the power source 202, there is observed energy returning to the load 206 given the timing of the neutralizing of the stator electromagnet generated by the coil 110.

In some embodiments, the control circuit leaves a relatively small period of elapsed time between the switching of the magnetic poles of the electromagnet induced by the coil 110 and timing of the rotation of the magnet 112 around the coil 110 energy is returned back into the load 206.

In some embodiments, features of electromechanical kinetic motor 100 include:
Energy transfer from the magnet 112 creating a generator and motor simultaneously with low-wattage usage
Amperage magnification/amplification as a result of the unique electrical circuitry
Powerful kinetic force generation (>10 kg) momentary pulses as a result of like poles repulsion and unlike poles attraction caused by the electro-magnetic and permanent magnetic forces.
Minimal heat being generated testifying of a closed loop efficient system
Less than 60 watts usage to produce 1300 RPM of kinetic forces over 10 kg
Minimal depletion of battery
Multiple sets of rotor/stator assemblies can be included, for cumulative power gains.

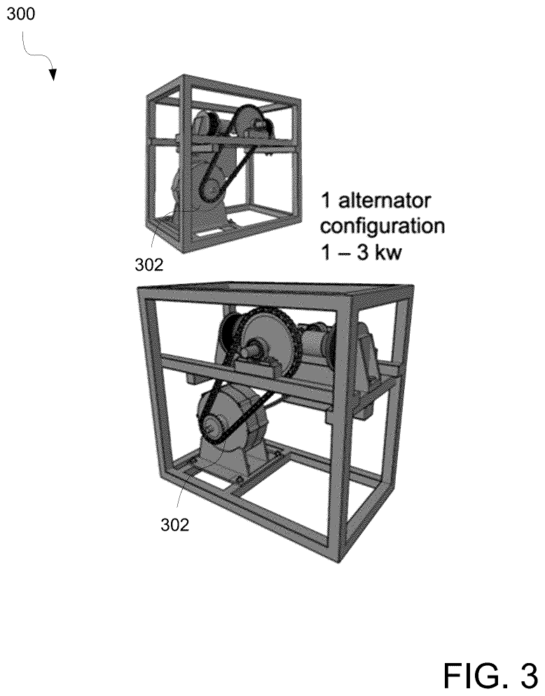

FIG. 3 depicts multiple views of one embodiment of a prototype electromechanical kinetic motor 300 configured with one alternator 302. The alternator 302 may be any type of alternator or generator know in the art. The alternator is connected to the rotor 106 and extracts kinetic energy from the rotor 106 and converts kinetic energy into electrical energy. In some embodiments, the alternator 302 may be capable of generating 1-3 kW.

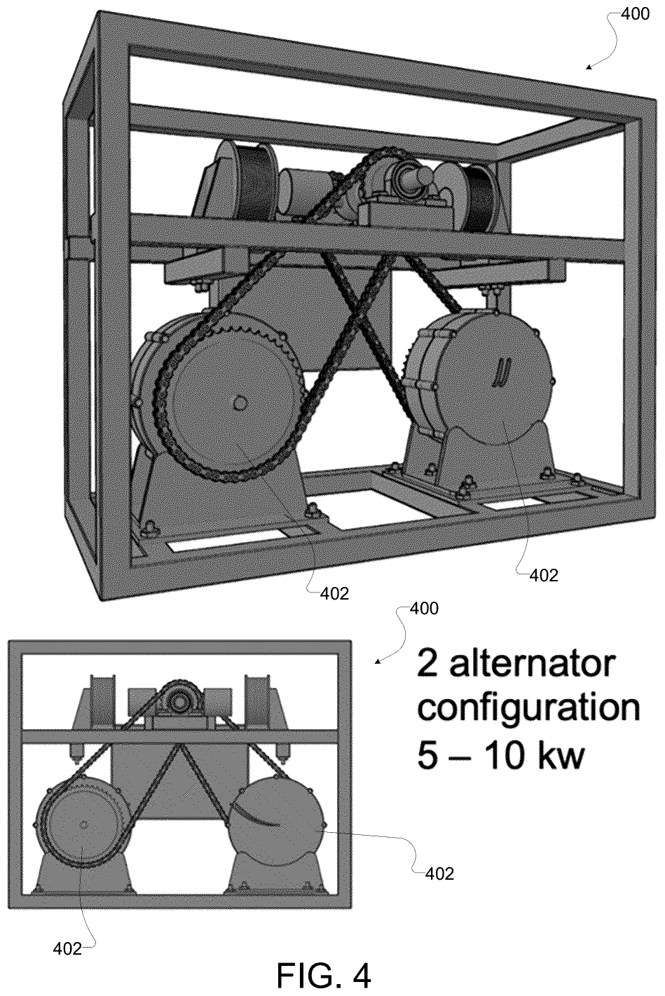

FIG. 4 depicts multiple views of a prototype electromechanical kinetic motor 400 configured with two alternators 402, generating 5-10 kW.

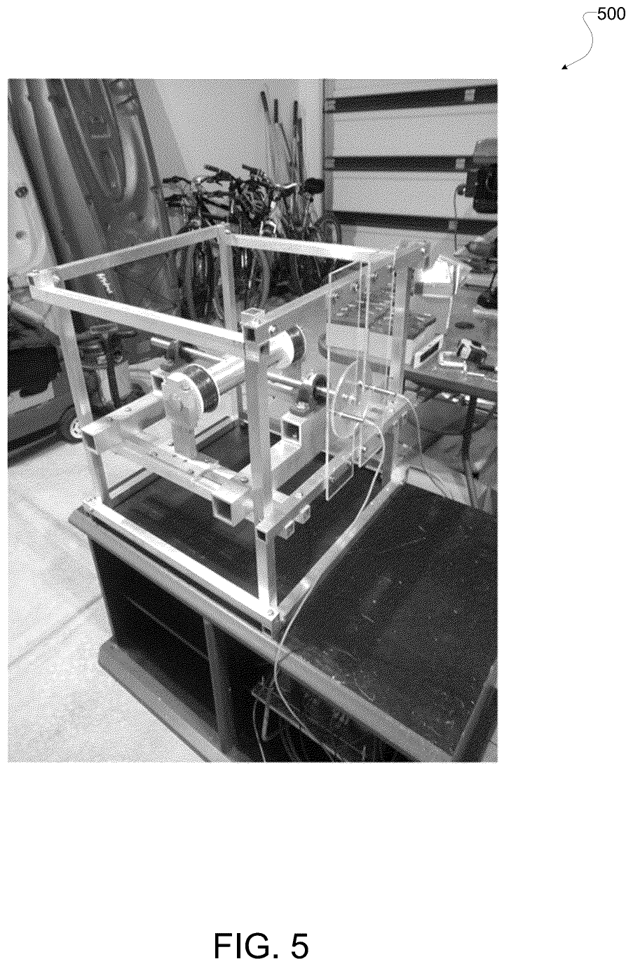

FIG. 5 depicts a perspective view of an electromechanical kinetic motor prototype 500.

Applications include amplification of renewable energy generation and battery energy storage solution, electric transportation (cars, boats, trains, airplanes, vehicles) recharging, electrical energy regenerators to supplement electrical energy drawn from the electricity power grid, amplification of electricity transmission, powering anything that uses kinetic energy for pumping fluids or liquids, etc.

In another embodiment, multiple permanent magnets 112 (i.e., greater than 2) may be added to the stator 104 and spinning rotor 106 comprising the magnet-flywheel assembly. These permanent magnets serve to “amplify” the magnetic flux and strength of each “pulse force” or push/pull strength.

A second, third, forth, etc. vertical rotor axis may be used to amplify the consistency of the kinetic energy being generated. The additional vertical axis between 1 and 360 axis may possibly increase the consistency of the magnetic push and pull forces. The number of magnets attached together reconfigures the magnetic domain of ending up with either a north or south pole. There is not a limit to the number of permanent magnets that can be added since the larger the diameter the larger the torque given the bigger distance traveled. Amplification of the magnetic field is also observed as more magnets are attached together. Additional magnets paired together may create a unique magnetic flux result set.

In one aspect, the permanent magnet-flywheel assembly includes n permanent magnets. Using a number of permanent magnets greater than 2 increases the pulse force with a vertical axis in addition to a horizontal axis, as compared to the pulse force generated if 2 magnets are used. A larger diameter 4 inches to 100 feet gives more travel by added magnets on the same axis.

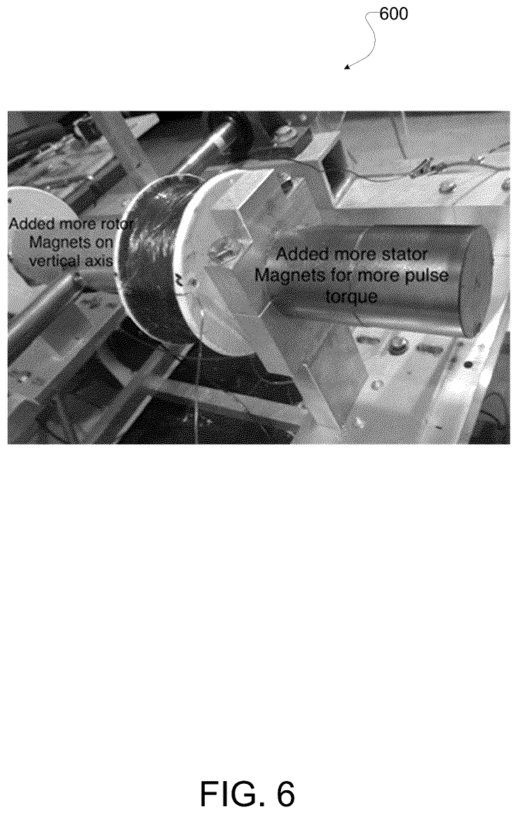

FIG. 6 depicts an embodiment of an electromechanical kinetic motor 600 that uses more than two permanent magnets for the stator and rotor.

In another embodiment multiple stator coils can be placed around the permanent magnet rotor path (flywheel). These additional coils act as electric generators ONLY and can produce additional electrical power. The power generated by these additional coils can also be put back into the circuit to create more power, efficiency, and mechanical energy (this mechanical energy can also be harnessed by a separate alternator or generator).

These additional coils are only generators and differ from the other electromagnetic coils stators (already described) that can receive input energy from the battery that creates the pulsing, alternating magnetic field that rotates the permanent magnets on the flywheel (motor).

One embodiment of this would be two stator electromagnetic coils that act as electric motors only and four stator coils that act as electric generators (or alternators) only.

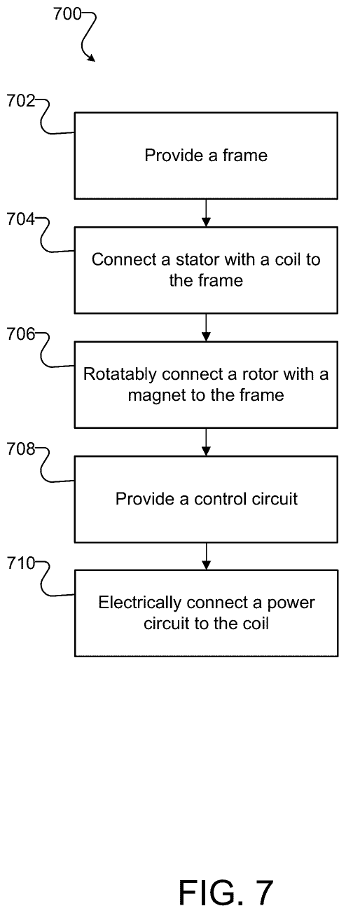

FIG. 7 is a flowchart diagram depicting one embodiment of a method 700 for manufacturing an electromechanical kinetic motor 100. The method 700 is in certain embodiments a method of use or manufacture of the system and apparatus of FIGS. 1-6, and will be discussed with reference to those figures. Nevertheless, the method 700 may also be conducted independently thereof and is not intended to be limited specifically to the specific embodiments discussed above with respect to those figures.

As shown in FIG. 7, a frame 102 is provided 702. The frame 102 may provide connection points and support for other elements of the electromechanical kinetic motor 100. In certain embodiments, a stator 104 is provided 704 and attached to the frame 102. The stator 104 may include one or more coils 110 each configured to act as an electromagnet.

A rotor 106 is provided 706 and rotatably attached to the frame 102 via a bearing 108 in some embodiments. The rotor 106 may include one or more magnets 112.

In some embodiments, a control circuit is provided 708. The control circuit may direct a modification of the electric current provided to the coil 110 in response to an angular position of the rotor 106. A power circuit 204 may be provided 710. The power circuit 204 may be electrically connected to the coil 110 and provide an electric current to create an electromagnet in the coil 110. The power circuit 204 may also include a load 206 that consumes power.

The components described herein may include any materials capable of performing the functions described. Said materials may include, but are not limited to, steel, stainless steel, titanium, tool steel, aluminum, polymers, and composite materials. The materials may also include alloys of any of the above materials. The materials may undergo any known treatment process to enhance one or more characteristics, including but not limited to heat treatment, hardening, forging, annealing, and anodizing. Materials may be formed or adapted to act as any described components using any known process, including but not limited to casting, extruding, injection molding, machining, milling, forming, stamping, pressing, drawing, spinning, deposition, winding, molding, and compression molding.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by any claims appended hereto and their equivalents.

What is claimed is:

1. A electromechanical kinetic motor comprising:
a frame;
a stator connected to the frame, the stator including a coil;
a rotor rotatably connected to the frame, the rotor including a magnet; and
a power source electrically connected to the coil;
an electric load connected to the coil, the electric load configured to extract power from the coil;
wherein:
the coil generates an electromagnetic field in response to electricity provided by the power source;
the rotor is configured to rotate the magnet through the magnetic field generated by the coil; and
an electric current is induced in the coil by the rotation of the magnet through the electromagnetic field generated by the coil.

2. The electromechanical kinetic motor of claim 1 further comprising a second magnet connected to the rotor.

3. The electromechanical kinetic motor of claim 2 wherein the second magnet is disposed 180 degrees of rotation of the rotor from the magnet.

4. The electromechanical kinetic motor of claim 1 further comprising a second coil wherein the second coil is connected to the frame in a location opposite the coil relative to the rotor.

5. The electromechanical kinetic motor of claim 1 comprising one or more pairs of coils wherein each coil in a pair of coils is connected to the frame in a location opposite the other coil in the pair of coils relative to the rotor.

6. The electromechanical kinetic motor of claim 5 wherein the pairs of coils are disposed around the rotor uniformly.

7. The electromechanical kinetic motor of claim 1 further comprising an alternator connected to the rotor wherein the alternator generates electric current in response to rotation of the rotor.

8. A method of manufacturing an electromechanical kinetic motor, the method comprising:
providing a frame;
connecting a stator with a coil to the frame;
rotatably connecting a rotor with a magnet to the frame;
providing a control circuit configured to control the electricity provided to the coil from a power source; and
electrically connecting a power circuit to the coil.
